(19) United States
(12) Patent Application Publication
(10) Pub. No.: US 2026/0114659 A1
(43) Pub. Date: Apr. 30, 2026

(54) MILK POWDER BIN STRUCTURE AND MILK POWDER BREWING MACHINE

(71) Applicant: FOSHAN SHUNDE NARTISAN ELECTRICAL APPLIANCE CO., LTD., Foshan (CN)

(72) Inventors: Jianwen Zhou, Foshan (CN); Jianmin Liang, Foshan (CN); Qiuyuan Lai, Foshan (CN)

(21) Appl. No.: 19/179,425

(22) Filed: Apr. 15, 2025

(30) Foreign Application Priority Data
Jun. 24, 2024 (CN) 2024214520975
Feb. 28, 2025 (CN) 2025203501975

(51) Int. Cl. A47J 31/40; A47J 31/44

(52) U.S. Cl. CPC A47J 31/40; A47J 31/4403

(57) ABSTRACT

A milk powder bin structure includes a milk powder storage bin, a milk powder dropping bin, a stirring assembly and a milk powder blocking assembly. A milk powder discharge channel is disposed at a bottom of the milk powder storage bin. The milk powder dropping bin is positioned below and detachably connected to the milk powder storage bin, a milk powder dropping port is disposed at the bottom of the milk powder storage bin, and is in communication with the milk powder discharge channel. The stirring assembly is disposed in the milk powder storage bin, a stirring shaft of the stirring assembly extends in an up-down direction, an arch-breaking structure is disposed at a lower end of the stirring shaft, and partially inserted into the milk powder discharge channel. The milk powder blocking assembly is configured to block or open the milk powder dropping port.

### REFERENCE TO RELATED APPLICATIONS

This application is based on and claims the benefit of priority from Chinese Patent Application No. 2024214520975 filed on Jun. 24, 2024, and No. 2025203501975 filed on Feb. 28, 2025, which are incorporated by reference herein in their entirety.

### BACKGROUND OF THE INVENTION

### Technical Field

The present disclosure relates to the technical field of milk powder brewing machines, and in particular, to a milk powder bin structure and a milk powder brewing machine.

### Background

At present, the milk powder bin in a milk powder brewing machine is prone to blockage at a discharge port in a discharging process, causing that the milk powder cannot be discharged smoothly through the discharge port. Moreover, the milk powder bin is inconvenient to clean due to a complex internal structure.

### SUMMARY

The present disclosure aims to solve one of the technical problems in the related technology at least to a certain extent. To this end, a milk powder bin structure and a milk powder brewing machine are provided.

In a first aspect, an embodiment of the present disclosure provides a milk powder bin structure, and the milk powder bin structure includes:
a milk powder storage bin, a milk powder discharge channel being disposed at a bottom of the milk powder storage bin;
a milk powder dropping bin positioned below the milk powder storage bin and detachably connected to the milk powder storage bin, where a milk powder dropping port is disposed at the bottom of the milk powder storage bin, and the milk powder discharge channel is in communication with the milk powder dropping port;
a stirring assembly disposed in the milk powder storage bin, where a stirring shaft of the stirring assembly extends in an up-down direction, the stirring assembly can be driven to rotate around the stirring shaft, an arch-breaking structure is disposed at a lower end of the stirring shaft, and the arch-breaking structure is partially inserted into the milk powder discharge channel; and
a milk powder blocking assembly configured to block or open the milk powder dropping port.

According to the embodiment of the present disclosure, the milk powder bin structure has at least the following technical effects. When the stirring shaft is rotating, the arch-breaking structure can break the arch of the milk powder, to ensure that the milk powder in the milk powder storage bin can pass through the milk powder discharge channel smoothly. The milk powder storage bin is detachably connected to the milk powder dropping bin, facilitating mutual separation for separate cleaning.

According to some embodiments of the present disclosure, an inner wall of the milk powder storage bin includes an annular wall and a conical wall; and a lower end of the annular wall is connected to an upper end of the conical wall, and the conical wall gradually approaches to an axis of the milk powder storage bin from top to bottom.

According to some embodiments of the present disclosure, the stirring assembly includes the stirring shaft and a plurality of stirring blades; a coupling member configured for connecting to a drive component is disposed at an upper end of the stirring shaft, the arch-breaking structure surrounds the stirring shaft spirally, one end of each of the stirring blades is fixedly connected to the stirring shaft, and the plurality of stirring blades are distributed circumferentially around the stirring shaft.

According to some embodiments of the present disclosure, the stirring assembly includes the stirring shaft, a first stirring blade and a second stirring blade; the coupling member configured for connecting to a drive component is disposed at an upper end of the stirring shaft, the arch-breaking structure surrounds the stirring shaft spirally, each of the first stirring blade and the second stirring blade is U-shaped, both ends of the first stirring blade are fixedly connected to the stirring shaft, respectively, and both ends of the second stirring blade are fixedly connected to the stirring shaft, respectively; a distance between the first stirring blade and an inner peripheral wall of the milk powder storage bin is smaller than that between the second stirring blade and the inner peripheral wall of the milk powder storage bin, and the first stirring blade and the second stirring blade are both provided with a second milk powder sweeping portion.

According to some embodiments of the present disclosure, a first bracket is disposed in the milk powder storage bin, the first bracket extends in a horizontal direction, two slots are provided on an inner wall of the milk powder storage bin, two ends of the first bracket are in snap-fit with the two slots, respectively, the stirring shaft is disposed to pass through the first bracket and rotatably connected to the first bracket, a second bracket is disposed in the milk powder storage bin, the second bracket extends in a vertical direction, an upper end of the second bracket is fixedly connected to the first bracket, and a first milk powder sweeping portion is disposed at a lower end of the second bracket.

According to some embodiments of the present disclosure, a first milk powder delivery barrel is disposed at a lower end of the milk powder storage bin, an inner cavity of the first milk powder delivery barrel constitutes the milk powder discharge channel, a raised portion is disposed on an outer peripheral wall of the first milk powder delivery barrel, the milk powder dropping bin is provided with a second milk powder delivery barrel, a buckle portion is disposed on an inner peripheral wall of the second milk powder delivery barrel, the first milk powder delivery barrel can be inserted into the second milk powder delivery barrel such that the raised portion is in snap-fit with the buckle portion, a first groove and a second groove are formed in the inner peripheral wall of the second milk powder delivery barrel, the first groove extends in a vertical direction, the second groove extends along a circumferential direction of the second milk powder delivery barrel, a lower end of the first groove is in communication with one end of the second groove, and the buckle portion is disposed in the second groove.

According to some embodiments of the present disclosure, the milk powder blocking assembly includes a milk powder blocking plate and a reset member; the milk powder blocking plate is rotatably connected to the milk powder dropping bin, the reset member is configured to apply a torque force to the milk powder blocking plate to rotate toward the milk powder dropping port, the milk powder dropping bin is provided with an arc-shaped limiting hole, the milk powder blocking plate is provided with a limiting column, and the limiting column is disposed to pass through the arc-shaped limiting hole; and a lower end of the milk powder dropping bin is detachably connected to a milk powder receiving cover, the milk powder dropping port is in communication with an inner cavity of the milk powder receiving cover, and the milk powder receiving cover is provided with a milk powder outlet.

According to some embodiments of the present disclosure, a stainless steel milk powder discharge sleeve is disposed at a lower end of the milk powder storage bin, an inner cavity of the stainless steel milk powder discharge sleeve constitutes the milk powder discharge channel, an inner diameter of the stainless steel milk powder discharge sleeve gradually decreases from top to bottom, a static elimination module is disposed in the milk powder dropping bin, and the static elimination module is configured to eliminate static electricity of the stainless steel milk powder discharge sleeve.

According to some embodiments of the present disclosure, the static elimination module is disposed in the milk powder dropping bin, and the static elimination module is configured to eliminate static electricity of the stainless steel milk powder discharge sleeve; or,
a conductive sheet is disposed on an outer wall of the milk powder storage bin, one end of the conductive sheet is connected to the stainless steel milk powder discharge sleeve, and another end of the conductive sheet is connected to a ground wire; or,
an upper end of the milk powder storage bin is slidingly connected to a metal spring pin, a lower end of the metal spring pin abuts against the stirring shaft, an outer side of the arch-breaking structure abuts against an inner peripheral wall of the stainless steel milk powder discharge sleeve, and an upper end of the metal spring pin is connected to the ground wire.

In a second aspect, an embodiment of the present disclosure further provides a milk powder brewing machine, which includes the milk powder bin structure according to the embodiment of the first aspect of the present disclosure.

According to the embodiment of the present disclosure, the milk powder brewing machine has at least the following technical effects. The milk powder brewing machine uses this milk powder bin structure. When the stirring shaft is rotating, the arch-breaking structure can break the arch of the milk powder, to ensure that the milk powder in the milk powder storage bin can pass through the milk powder discharge channel smoothly. The milk powder storage bin is detachably connected to the milk powder dropping bin, facilitating mutual separation for separate cleaning.

Additional aspects and advantages of the present disclosure will be given in part in the following description, and in part will become apparent from the following description, or will be learned through the practice of the present disclosure.

### BRIEF DESCRIPTION OF DRAWINGS

The above and/or additional aspects and advantages of the present disclosure will become apparent and easily understood from the description of the embodiments in conjunction with the following accompanying drawings, in which:

FIG. 1 is a schematic structural diagram of a milk powder bin structure according to some embodiments of the present disclosure;

FIG. 2 is a cross-sectional view of a milk powder bin structure according to some embodiments of the present disclosure;

FIG. 3 is an exploded view of a milk powder bin structure according to some embodiments of the present disclosure;

FIG. 4 is a schematic structural diagram of a milk powder dropping bin according to some embodiments of the present disclosure;

FIG. 5 is a schematic structural diagram of a milk powder dropping bin from another perspective according to some embodiments of the present disclosure;

FIG. 6 is a schematic structural diagram of another milk powder bin structure according to some embodiments of the present disclosure;

FIG. 7 is a cross-sectional view of another milk powder bin structure according to some embodiments of the present disclosure;

FIG. 8 is an exploded view of another milk powder bin structure according to some embodiments of the present disclosure;

FIG. 9 is a cross-sectional view of another milk powder bin structure according to some embodiments of the present disclosure; and

FIG. 10 is a cross-sectional view of another milk powder bin structure according to some embodiments of the present disclosure.

### REFERENCE NUMERALS

milk powder storage bin 100, milk powder discharge channel 110, annular wall 121, conical wall 122, slot 130, first milk powder delivery barrel 140, raised portion 15, metal spring pin 160, conductive sheet 170;

milk powder dropping bin 200, milk powder dropping port 210, second milk powder delivery barrel 220, first groove 231, second groove 232, buckle portion 240, arc-shaped limiting hole 250, stainless steel milk powder discharge sleeve 260, static elimination module 270, milk powder receiving cover 280, milk powder outlet 281;

stirring assembly 300, stirring shaft 310, stirring blade 320, arch-breaking structure 321, coupling member 322, first bracket 330, second bracket 340, first milk powder sweeping portion 341, first stirring blade 351, second stirring blade 352, second milk powder sweeping portion 353;

milk powder blocking assembly 400, milk powder blocking plate 410, reset member 420, limiting column 430, connecting column 431, barrel cover 440, handle 450.

### DETAILED DESCRIPTION

Embodiments of the present disclosure will be described in detail below. Examples of the embodiments are illustrated in the accompanying drawings, where the same or like reference numerals throughout the figures indicate the same or like elements having the same or like functions. The embodiments described below with reference to the accompanying drawings are exemplary and are intended only to explain the present disclosure instead of being construed as limiting the present disclosure.

In the description of the present disclosure, it should be understood that, descriptions relating to orientation, for example, orientation or positional relationships indicated by “up”, “down”, etc. are based on the orientation or positional relationships shown in the accompanying drawings, and are to facilitate the description of the present disclosure and simplify the description only, rather than indicating or implying that the device or element referred to must have a specific orientation or be constructed and operated in a specific orientation, and therefore cannot be construed as limiting the present disclosure.

In the description of the present disclosure, the meaning of “several” is one or more, the meaning of “a plurality of” is two or more, “greater than”, “less than”, “more than”, etc. are to be understood to exclude the given figure, and “above”, “below”, “within”, etc. are understood to include the given figure. If “first” and “second”, etc. are referred to, it is only for the purpose of distinguishing technical features, and shall not be understood as indicating or implying relative importance or implying the number of the indicated technical features or implying the sequence of the indicated technical features.

In the description of the present disclosure, unless otherwise explicitly defined, the words such as “set”, “install”, and “connect” should be understood in a broad sense, and those of ordinary skill in the art can determine the specific meanings of the above words in the present disclosure in a rational way in combination with the specific contents of the technical solutions.

The embodiment of present disclosure is further described in combination with the accompanying drawings below.

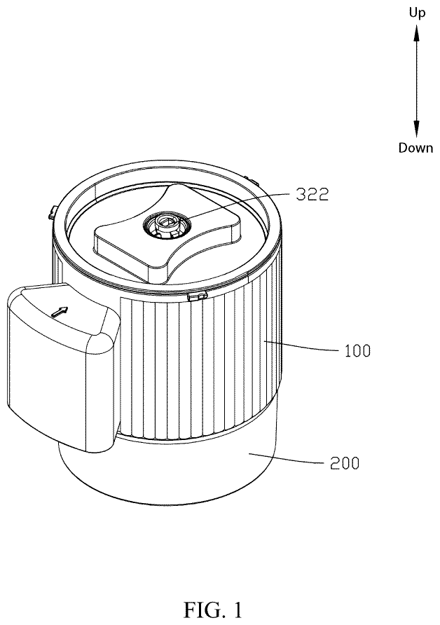

According to some embodiments of the present disclosure, referring to FIG. 1 to FIG. 3, a milk powder bin structure is provided, which includes a milk powder storage bin 100, a milk powder dropping bin 200, a stirring assembly 300 and a milk powder blocking assembly 400. An axial direction of the milk powder storage bin 100 is an up-down direction. A milk powder discharge channel 110 is disposed at a bottom of the milk powder storage bin 100. The milk powder discharge channel 110 is coaxially disposed with the milk powder storage bin 100. The milk powder dropping bin 200 is positioned below the milk powder storage bin 100 and detachably connected to the milk powder storage bin 100. A milk powder dropping port 210 is disposed at the bottom of the milk powder storage bin 100, and the milk powder discharge channel 110 is in communication with the milk powder dropping port 210. The stirring assembly 300 is disposed in the milk powder storage bin 100, a stirring shaft 310 of the stirring assembly 300 extends in an up-down direction, the stirring assembly 300 can be driven to rotate around the stirring shaft 310. An arch-breaking structure 321 is disposed at a lower end of the stirring shaft 310, and the arch-breaking structure 321 is partially inserted into the milk powder discharge channel 110. The milk powder blocking assembly 400 is configured to block or open the milk powder dropping port 210.

When the milk powder needs to be dropped, the milk powder dropping port 210 is opened through the milk powder blocking assembly 400, and the milk powder in the milk powder storage bin 100 drops downward through the milk powder discharge channel 110 and the milk powder dropping port 210 in sequence. The milk powder may form an arch in the milk powder discharge channel 110 and at the entrance of the milk powder discharge channel 110. When the stirring shaft 310 is rotating, the arch-breaking structure 321 can break the arch of the milk powder, to ensure that the milk powder in the milk powder storage bin 100 can pass through the milk powder discharge channel 110 smoothly. Meanwhile, since the stirring shaft 310 is coaxially disposed with the milk powder storage bin 100, the milk powder in the milk powder storage bin 100 is concentrated from the surroundings to the middle, which has the faster milk powder dropping efficiency than the traditional milk powder needing to move to milk powder grids on the surroundings. Moreover, the milk powder storage bin 100 is detachably connected to the milk powder dropping bin 200, facilitating mutual separation for separately cleaning the milk powder dropping port 210 and the milk powder discharge channel 110.

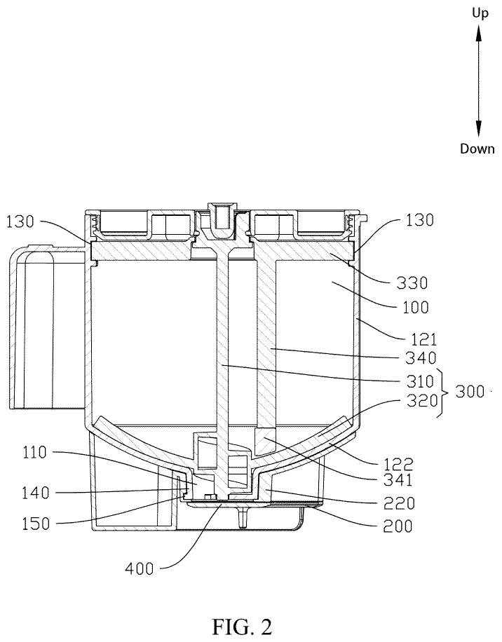

According to some embodiments of the present disclosure, referring to FIG. 2, an inner wall of the milk powder storage bin 100 includes an annular wall 121 and a conical wall 122. A lower end of the annular wall 121 is connected to an upper end of the conical wall 122, and the conical wall 122 gradually approaches to an axis of the milk powder storage bin 100 from top to bottom. The conical wall 122 can guide the milk powder to move toward the axis direction of the milk powder storage bin 100 from top to bottom, so as to facilitate the milk powder to concentrate in the milk powder discharge channel 110.

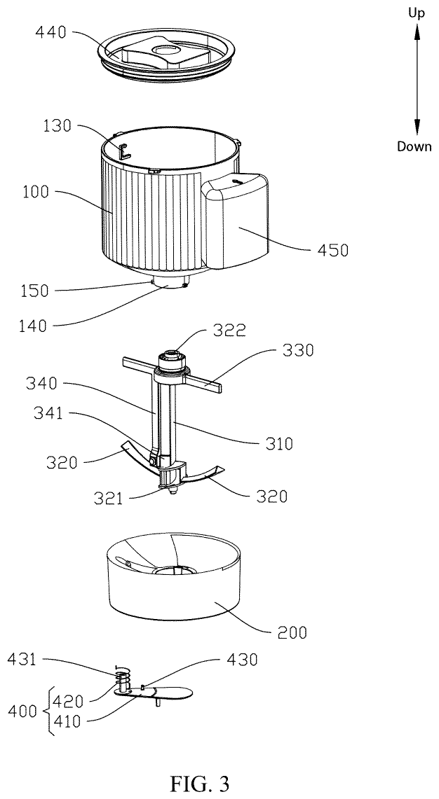

According to some embodiments of the present disclosure, referring to FIG. 2 and FIG. 3, the stirring assembly 300 includes the stirring shaft 310 and a plurality of stirring blades 320. A coupling member 322 configured for connecting to a drive component is disposed at an upper end of the stirring shaft 310, such that a drive end of the drive component can be relatively fixed to the stirring shaft 310, and the drive component drives the stirring shaft 310 to rotate. The arch-breaking structure 321 surrounds the stirring shaft 310 spirally, and is configured as a helically ascending plate. During the rotation of the stirring shaft 310, the milk powder can pass through the arch-breaking structure 321 and then pass downward through the milk powder discharge channel 110. One end of each of the stirring blades 320 is fixedly connected to the stirring shaft 310, and the plurality of stirring blades 320 are distributed circumferentially around the stirring shaft 310.

Further, referring to FIG. 2, the stirring blades 320 are tightly attached to the conical wall 122, such that the stirring blades 320 can sweep the milk powder along the conical wall 122 under the rotation of the stirring shaft 310, thereby preventing the milk powder from adhering to the conical wall 122.

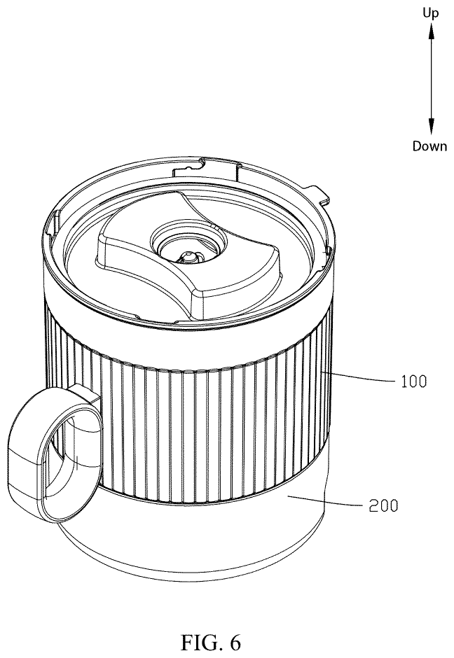

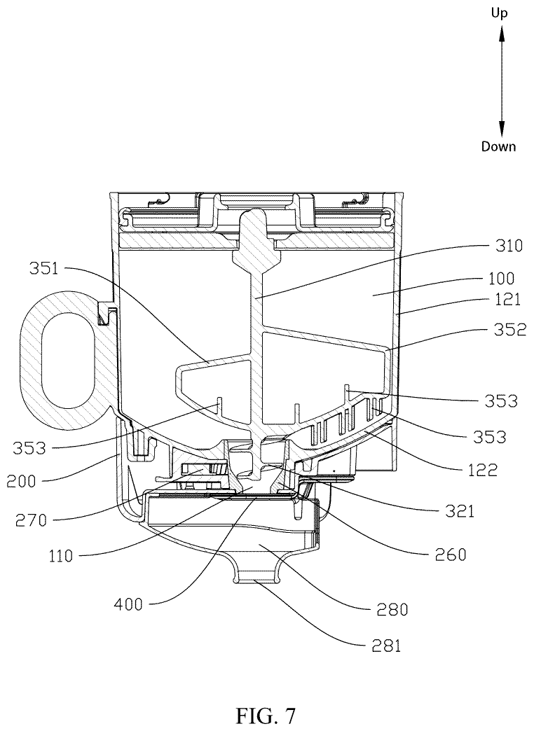

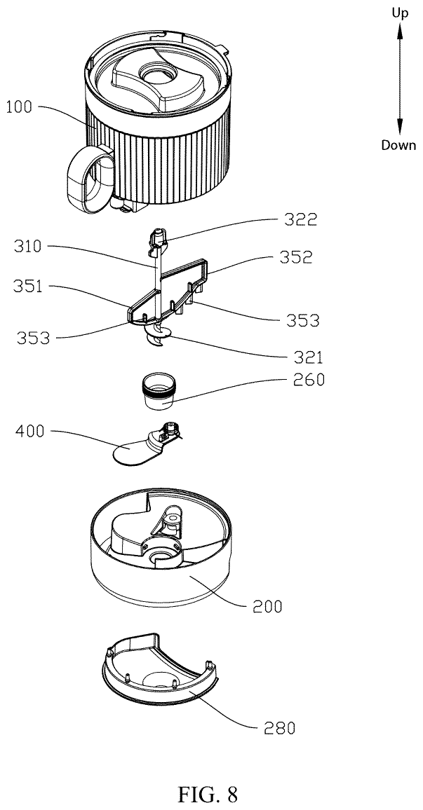

According to some embodiments of the present disclosure, referring to FIG. 6 to FIG. 8, the stirring assembly 300 includes the stirring shaft 310, a first stirring blade 351 and a second stirring blade 352. The coupling member 322 configured for connecting to the drive component is disposed at the upper end of the stirring shaft 310. The arch-breaking structure 321 surrounds the stirring shaft 310 spirally. Each of the first stirring blade 351 and the second stirring blade 352 is U-shaped. Both ends of the first stirring blade 351 are fixedly connected to the stirring shaft 310, respectively, and both ends of the second stirring blade 352 are fixedly connected to the stirring shaft 310, respectively. The first stirring blade 351 and the second stirring blade 352 are in a same plane, a lower end of the first stirring blade 351 and a lower end of the second stirring blade 352 are at a same height, and an upper end of the first stirring blade 351 is lower than that of the second stirring blade 352. A distance between the first stirring blade 351 and an inner peripheral wall of the milk powder storage bin 100 is smaller than that between the second stirring blade 352 and the inner peripheral wall of the milk powder storage bin 100, and the first stirring blade 351 and the second stirring blade 352 are both provided with a second milk powder sweeping portion 353. The first stirring blade 351 and the second stirring blade 352 cooperate to fully stir materials, to prevent the materials from accumulating and getting stuck in the milk powder storage bin 100. The second milk powder sweeping portion 353 can further stir the materials, to prevent the materials from accumulating and getting stuck in the milk powder storage bin 100.

According to some embodiments of the present disclosure, referring to FIG. 2 and FIG. 3, a first bracket 330 is disposed in the milk powder storage bin 100, and the first bracket 330 extends in a horizontal direction. Two slots 130 are provided on an inner wall of the milk powder storage bin 100, and two ends of the first bracket 330 are in snap-fit with the two slots 130, respectively. The stirring shaft 310 is disposed to pass through the first bracket 300 and rotatably connected to the first bracket 330. It can be understood that the first bracket 330 can serve to support the stirring shaft 310, to prevent the stirring shaft 310 from being offset and ensure that the axial direction of the stirring shaft 310 is in the up-down direction. Meanwhile, the first bracket 330 is detachably connected to the milk powder storage bin 100, which facilitates the disassembly and separation of the stirring shaft 310 and the stirring blades 320 from the milk powder storage bin 100 for cleaning.

Further, referring to FIG. 2 and FIG. 3, a second bracket 340 is disposed in the milk powder storage bin 100, the second bracket 340 extends in a vertical direction, an upper end of the second bracket 340 is fixedly connected to the first bracket 330, and a first milk powder sweeping portion 341 is disposed at a lower end of the second bracket 340. The first milk powder sweeping portion 341 serves to guide the milk powder to concentrate in the middle, and also serves to break the arch.

According to some embodiments of the present disclosure, referring to FIG. 2 to FIG. 4, a first milk powder delivery barrel 140 is disposed at a lower end of the milk powder storage bin 100. An inner cavity of the first milk powder delivery barrel 140 constitutes the milk powder discharge channel 110. Upper and lower ends of the first milk powder delivery barrel 140 are both opened, and the upper end of the first milk powder delivery barrel 140 is in communication with an inner cavity of the milk powder storage bin 100. A raised portion 150 is disposed on an outer peripheral wall of the first milk powder delivery barrel 140. The milk powder dropping bin 200 is provided with a second milk powder delivery barrel 220, upper and lower ends of the second milk powder delivery barrel 220 are both opened, and a buckle portion 240 is disposed on an inner peripheral wall of the second milk powder delivery barrel 220. A lower end of the second milk powder delivery barrel 220 constitutes the milk powder dropping port 210, and the first milk powder delivery barrel 140 can be inserted into the second milk powder delivery barrel 220 such that the raised portion 150 and the buckle portion 240 are in buckle connection, and the milk powder dropping bin 200 is relatively fixed to the milk powder storage bin 100.

It should be noted that the relative fixation of the milk powder dropping bin 200 and the milk powder storage bin 100 can also be achieved by a threaded connection. For example, the second milk powder delivery barrel 220 is provided with an internal thread, the first milk powder delivery barrel 140 is provided with an external thread, and the first powder delivery barrel 140 and the second milk powder delivery barrel 220 are in threaded connection.

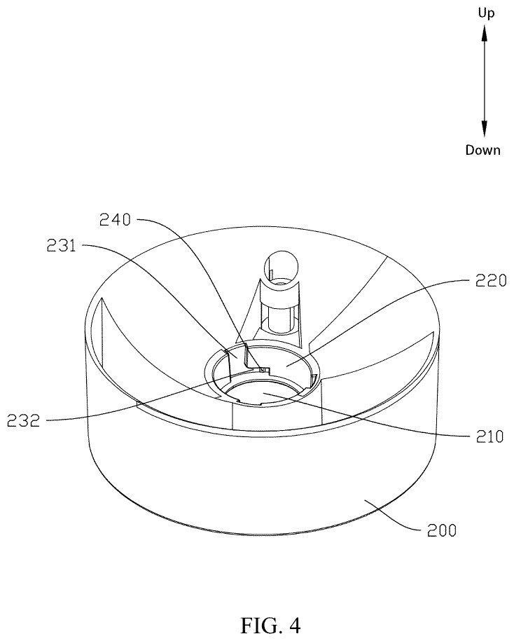

Further, referring to FIG. 3 and FIG. 4, a first groove 231 and a second groove 232 are formed in an inner peripheral wall of the second milk powder delivery barrel 220. The first groove 231 extends in the vertical direction, the second groove 232 extends in the circumferential direction of the second milk powder delivery barrel 220. A lower end of the first groove 231 is in communication with one end of the second groove 232, and the buckle portion 240 is disposed in the second groove 232. It can be understood that when the first milk powder delivery barrel 140 is inserted downward into the second milk powder delivery barrel 220, the raised portion 150 passes through the first groove 231, and then the first milk powder delivery barrel 140 rotates relative to the second milk powder delivery barrel 220, such that the raised portion 150 moves relative to the second groove 232, and moves to a position between the buckle portion 240 and another end of the second groove 232. The buckle portion 240 is elastic. When the raised portion 150 passes over the buckle portion 240 to be positioned between the buckle portion 240 and another end of the second groove 232, the buckle portion 240 and the second groove 232 cooperate to limit the rotation of the raised portion 150 relative to the second milk powder delivery barrel 220, such that the milk powder storage bin 100 is relatively fixed to the milk powder dropping bin 200.

According to some embodiments of the present disclosure, referring to FIG. 2 and FIG. 3, the milk powder blocking assembly 400 includes a milk powder blocking plate 410 and a reset member 420. The milk powder blocking plate 410 is rotatably connected to the milk powder dropping bin 200, and the reset member 420 is configured to apply a torque force to the milk powder blocking plate 410 to rotate toward the milk powder dropping port 210.

It can be understood that a connecting column 431 is disposed at an upper end of the milk powder blocking plate 410, the connecting column 431 is inserted into the milk powder dropping bin 200 and rotatably connected to the milk powder dropping bin 200. The reset member 420 is a torsional spring, the reset member 420 is sleeved over the connecting column 431, and two ends of the reset member 420 are connected to the milk powder blocking plate 410 and the milk powder dropping bin 200, respectively. In an initial state, the milk powder blocking plate 410 blocks the milk powder dropping port 210. When an external force is applied to the milk powder blocking plate 410 to rotate the milk powder blocking plate 410 to open the milk powder dropping port 210, the torsional force of the reset member 420 needs to be overcome. When the external force is released, the milk powder blocking plate 410 blocks the milk powder dropping port 210 again under the drive of the reset member 420.

It should be noted that the rotation of the milk powder blocking plate 410 can be controlled manually or by a drive motor.

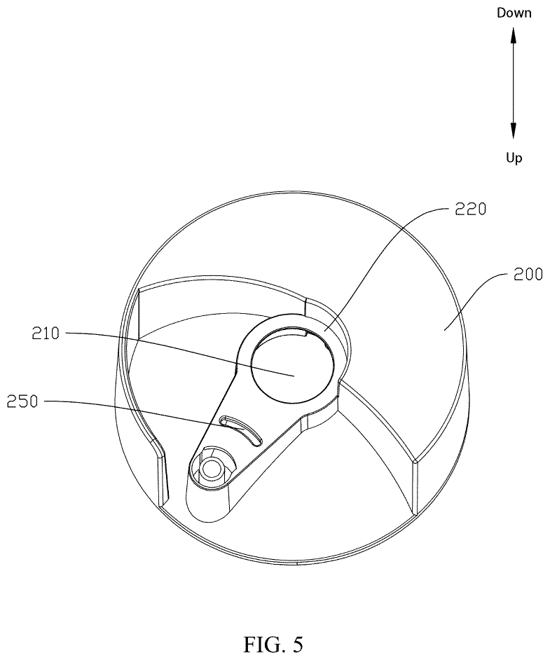

According to some embodiments of the present disclosure, referring to FIG. 4 and FIG. 5, the milk powder dropping bin 200 is provided with an arc-shaped limiting hole 250, the milk powder blocking plate 410 is provided with a limiting column 430, and the limiting column 430 is disposed to pass through the arc-shaped limiting hole 250. The arc-shaped limiting hole 250 can limit the rotation range of the milk powder blocking plate 410, to prevent the milk powder blocking plate 410 from damaging the reset member 420 due to excessive rotation.

Referring to FIG. 3, a barrel cover 440 is disposed at the upper end of the milk powder storage bin 100, and the barrel cover 440 covers the milk powder storage bin 100 to seal the upper end opening of the milk powder storage bin 100. A sealing rubber ring is disposed between the barrel cover 440 and the milk powder storage bin 100 to prevent milk powder from leaking and external impurities from entering the milk powder storage bin 100. A handle 450 is disposed on the outer peripheral wall of the milk powder storage bin 100, to facilitate carrying the milk powder storage bin 100.

A drive component is disposed on the milk powder brewing machine. The drive component is positioned at the upper end of the milk powder storage bin 100 and has a drive end facing downward. When the milk powder storage bin 100 is mounted on the milk powder brewing machine, the drive component is coupled to the stirring shaft 310.

According to some embodiments of the present disclosure, referring to FIG. 6 to FIG. 8, a stainless steel milk powder discharge sleeve 260 is provided at the lower end of the milk powder storage bin 100, and an inner cavity of the stainless steel milk powder discharge sleeve 260 constitutes the milk powder discharge channel 110. An inner diameter of the stainless steel milk powder discharge sleeve 260 gradually decreases from top to bottom, thereby guiding the milk powder in the milk powder storage bin 100 to flow to the middle of the stainless steel milk powder discharge sleeve 260. This avoids the milk powder being stuck in the stainless steel milk powder discharge sleeve 260. Further, a static elimination module 270 is disposed in the milk powder dropping bin 200, and the static elimination module 270 is configured to eliminate the static electricity of the stainless steel milk powder discharge sleeve 260, so as to prevent the milk powder from being attached to the inside of the stainless steel milk powder discharge sleeve 260 under the action of static electricity and unable to drop.

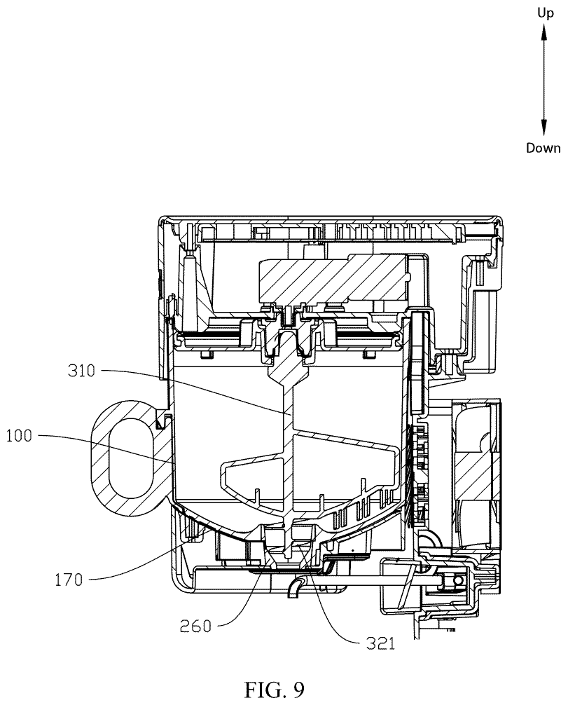

In some embodiments, referring to FIG. 9, a conductive sheet 170 is disposed on the outer wall of the milk powder storage bin 100, one end of the conductive sheet 170 is connected to the stainless steel milk powder discharge sleeve 260, and another end of the conductive sheet 170 is connected to the ground wire, thereby eliminating static electricity on the stainless steel milk powder discharge sleeve 260 through the conductive sheet 170. Preferably, a ground wire contact is disposed in the milk powder storage bin 100, the ground wire contact is connected to the conductive sheet 170, and the ground wire is connected to the ground wire contact and runs in parallel with a power wire. Alternatively, a conductive component is disposed in the milk powder storage bin 100, the conductive component is connected to the stainless steel milk powder discharge sleeve 260 and the ground wire conductive component, respectively, and the ground wire conductive component then runs in parallel with the ground wire, such that the static electricity of the stainless steel milk powder discharge sleeve 260 can be eliminated, to avoid milk powder accumulation.

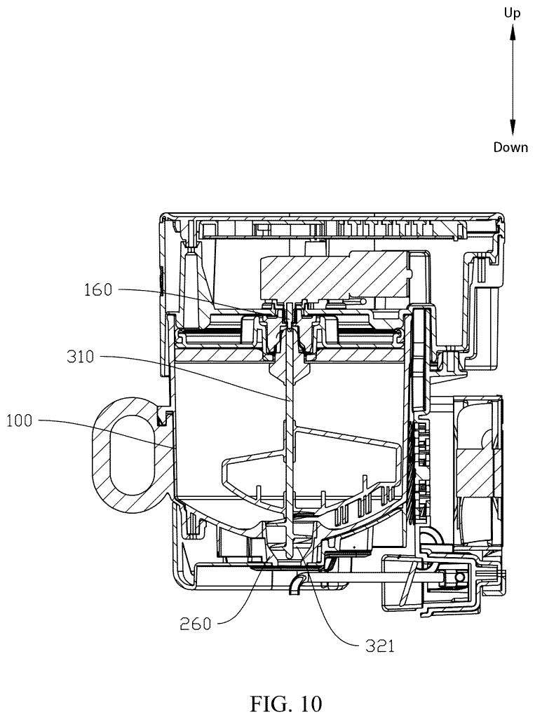

In some embodiments, referring to FIG. 10, an upper end of the milk powder storage bin 100 is slidingly connected to a metal spring pin 160, a lower end of the metal spring pin 160 abuts against the stirring shaft 310, and a spring of the metal spring pin 160 is in a compressed state and an upper end of the spring abuts against the milk powder storage bin 100. An outer side of the arch-breaking structure 321 abuts against an inner peripheral wall of the stainless steel milk powder discharge sleeve 260, and an upper end of the metal spring pin 160 is connected to the ground wire. The metal spring pin 160 is connected to a metal shell of the motor, the metal shell of the motor is connected to the ground wire, and the stirring shaft 310 and the arch-breaking structure 321 are both made of conductive materials, such that the static electricity of the stainless steel milk powder discharge sleeve 260 can be eliminated, to avoid milk powder accumulation.

According to some embodiments of the present disclosure, referring to FIG. 6 to FIG. 8, a milk powder receiving cover 280 is detachably connected to the lower end of the milk powder dropping bin 200, the milk powder dropping port 210 is in communication with an inner cavity of the milk powder receiving cover 280, and the milk powder receiving cover 280 is provided with a milk powder outlet 281. The milk powder in the milk powder storage bin 100 enters the milk powder receiving cover 280 through the milk powder discharge channel 110 and the milk powder dropping port 210. An inner diameter of the milk powder receiving cover 280 gradually decreases from top to bottom, thereby guiding the milk powder to flow toward the middle and then drop through the milk powder outlet 281.

In the description of the present disclosure, the description with reference to the term “some embodiments” intends to mean that the specific characteristics, structures, materials or features in combination with these embodiments or examples are included in at least one embodiment or example of the present disclosure. In this specification, the schematic expression of the above term does not necessarily refer to the same embodiment or example. Moreover, the described specific characteristics, structures, materials or features may be combined in one or more embodiments or examples in a suitable manner.

Although the embodiments of the present disclosure have been presented and described, those of ordinary skill in the art may understand that various changes, modifications, replacements and deformations can be made to these embodiments without deviating from the principle and gist of the present disclosure, and the scope of the present disclosure is defined by the appended claims and their equivalents.

1. A milk powder bin structure, comprising:
a milk powder storage bin, a milk powder discharge channel being disposed at a bottom of the milk powder storage bin;
a milk powder dropping bin positioned below the milk powder storage bin and detachably connected to the milk powder storage bin, wherein a milk powder dropping port is disposed at the bottom of the milk powder storage bin, and the milk powder discharge channel is in communication with the milk powder dropping port;
a stirring assembly disposed in the milk powder storage bin, wherein a stirring shaft of the stirring assembly extends in an up-down direction, the stirring assembly is able to be driven to rotate around the stirring shaft, an arch-breaking structure is disposed at a lower end of the stirring shaft, and the arch-breaking structure is partially inserted into the milk powder discharge channel; and
a milk powder blocking assembly configured to block or open the milk powder dropping port.

2. The milk powder bin structure according to claim 1, wherein an inner wall of the milk powder storage bin comprises an annular wall and a conical wall; and a lower end of the annular wall is connected to an upper end of the conical wall, and the conical wall gradually approaches to an axis of the milk powder storage bin from top to bottom.

3. The milk powder bin structure according to claim 1, wherein the stirring assembly comprises the stirring shaft and a plurality of stirring blades; a coupling member configured for connecting to a drive component is disposed at an upper end of the stirring shaft, the arch-breaking structure surrounds the stirring shaft spirally, one end of each of the stirring blades is fixedly connected to the stirring shaft, and the plurality of stirring blades are distributed circumferentially around the stirring shaft.

4. The milk powder bin structure according to claim 1, wherein the stirring assembly comprises the stirring shaft, a first stirring blade and a second stirring blade; the coupling member configured for connecting to a drive component is disposed at an upper end of the stirring shaft, the arch-breaking structure surrounds the stirring shaft spirally, each of the first stirring blade and the second stirring blade is U-shaped, both ends of the first stirring blade are fixedly connected to the stirring shaft, respectively, and both ends of the second stirring blade are fixedly connected to the stirring shaft, respectively; a distance between the first stirring blade and an inner peripheral wall of the milk powder storage bin is smaller than a distance between the second stirring blade and the inner peripheral wall of the milk powder storage bin, and the first stirring blade and the second stirring blade are both provided with a second milk powder sweeping portion.

5. The milk powder bin structure according to claim 1, wherein a first bracket is disposed in the milk powder storage bin, the first bracket extends in a horizontal direction, two slots are provided on an inner wall of the milk powder storage bin, two ends of the first bracket are in snap-fit with the two slots, respectively, the stirring shaft is disposed to pass through the first bracket and rotatably connected to the first bracket, a second bracket is disposed in the milk powder storage bin, the second bracket extends in a vertical direction, an upper end of the second bracket is fixedly connected to the first bracket, and a first milk powder sweeping portion is disposed at a lower end of the second bracket.

6. The milk powder bin structure according to claim 1, wherein a first milk powder delivery barrel is disposed at a lower end of the milk powder storage bin, an inner cavity of the first milk powder delivery barrel constitutes the milk powder discharge channel, a raised portion is disposed on an outer peripheral wall of the first milk powder delivery barrel, the milk powder dropping bin is provided with a second milk powder delivery barrel, a buckle portion is disposed on an inner peripheral wall of the second milk powder delivery barrel, the first milk powder delivery barrel is able to be inserted into the second milk powder delivery barrel such that the raised portion is in snap-fit with the buckle portion, a first groove and a second groove are formed in the inner peripheral wall of the second milk powder delivery barrel, the first groove extends in a vertical direction, the second groove extends along a circumferential direction of the second milk powder delivery barrel, a lower end of the first groove is in communication with one end of the second groove, and the buckle portion is disposed in the second groove.

7. The milk powder bin structure according to claim 1, wherein the milk powder blocking assembly comprises a milk powder blocking plate and a reset member; the milk powder blocking plate is rotatably connected to the milk powder dropping bin, the reset member is configured to apply a torque force to the milk powder blocking plate to rotate toward the milk powder dropping port, the milk powder dropping bin is provided with an arc-shaped limiting hole, the milk powder blocking plate is provided with a limiting column, and the limiting column is disposed to pass through the arc-shaped limiting hole; and a lower end of the milk powder dropping bin is detachably connected to a milk powder receiving cover, the milk powder dropping port is in communication with an inner cavity of the milk powder receiving cover, and the milk powder receiving cover is provided with a milk powder outlet.

8. The milk powder bin structure according to claim 1, wherein a stainless steel milk powder discharge sleeve is disposed at a lower end of the milk powder storage bin, an inner cavity of the stainless steel milk powder discharge sleeve constitutes the milk powder discharge channel, and an inner diameter of the stainless steel milk powder discharge sleeve gradually decreases from top to bottom.

9. The milk powder bin structure according to claim 8, wherein a static elimination module is disposed in the milk powder dropping bin, and the static elimination module is configured to eliminate static electricity of the stainless steel milk powder discharge sleeve.

10. The milk powder bin structure according to claim 8, wherein a conductive sheet is disposed on an outer wall of the milk powder storage bin, one end of the conductive sheet is connected to the stainless steel milk powder discharge sleeve, and another end of the conductive sheet is connected to a ground wire.

11. The milk powder bin structure according to claim 8, wherein an upper end of the milk powder storage bin is slidingly connected to a metal spring pin, a lower end of the metal spring pin abuts against the stirring shaft, an outer side of the arch-breaking structure abuts against an inner peripheral wall of the stainless steel milk powder discharge sleeve, and an upper end of the metal spring pin is connected to the ground wire.

12. A milk powder brewing machine, comprising the milk powder bin structure according to claim 1.
